(19) United States
(12) Patent Application Publication
(10) Pub. No.: US 2021/0187384 A1
(43) Pub. Date: Jun. 24, 2021

(54) ARITHMETIC EDUCATIONAL GAME

(71) Applicant: Rexie Wells, Inkster, MI (US)

(72) Inventor: Rexie Wells, Inkster, MI (US)

(21) Appl. No.: 16/723,951

(22) Filed: Dec. 20, 2019

(51) Int. Cl. A63F 3/04; G09B 19/22

(52) U.S. Cl. CPC A63F 3/0415; G09B 19/22

(57) ABSTRACT

An arithmetic educational game, including a game board, including a plurality of first colored shapes disposed on at least a portion of a front surface of the game board, a plurality of second colored shapes disposed on at least a portion of the front surface of the game board, a plurality of third colored shapes disposed on at least a portion of the front surface of the game board, and a plurality of fourth colored shapes disposed on at least a portion of the front surface of the game board, a ball to propel toward the game board, such that the ball connects to at least one of the plurality of first colored shapes, the plurality of second colored shapes, the plurality of third colored shapes, and the plurality of fourth colored shapes, and a plurality of cards to be drawn in response to the ball connecting to at least one of the plurality of first colored shapes and the plurality of second colored shapes.

### BACKGROUND

### 1. Field

The present general inventive concept relates generally to a game, and particularly, to an arithmetic educational game.

### 2. Description of the Related Art

Math is an important skill for children to learn, even from a young age. For example, in most public schools, math is often the only course required to be taken every year.

However, learning math can present challenges for children. Many games exist on the market to help young children with basic math skills, but not all of them incorporate physical activity, which can enrich the learning experience. Games are an excellent activity to facilitate learning because often times, a player is actively engaged in the game. As such, combining games and education can keep children active while learning.

Therefore, there is a need for an educational game that utilizes a physical activity.

### SUMMARY

The present general inventive concept provides an arithmetic educational game.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an arithmetic educational game, including a game board, including a plurality of first colored shapes disposed on at least a portion of a front surface of the game board, a plurality of second colored shapes disposed on at least a portion of the front surface of the game board, a plurality of third colored shapes disposed on at least a portion of the front surface of the game board, and a plurality of fourth colored shapes disposed on at least a portion of the front surface of the game board, a ball to propel toward the game board, such that the ball connects to at least one of the plurality of first colored shapes, the plurality of second colored shapes, the plurality of third colored shapes, and the plurality of fourth colored shapes, and a plurality of cards to be drawn in response to the ball connecting to at least one of the plurality of first colored shapes and the plurality of second colored shapes.

The plurality of first colored shapes may be a first color.

The plurality of second colored shapes may be a second color.

The plurality of third colored shapes may be a third color.

The plurality of fourth colored shapes may be a fourth color.

The plurality of first colored shapes, the plurality of second colored shapes, the plurality of third colored shapes, and the plurality of fourth colored shapes each may include a fastener to prevent the ball from falling in response to connecting to the game board.

The ball may include a fastener portion disposed on a surface of the ball to connect the ball to the game board.

The plurality of cards may include a first set corresponding to the plurality of first colored shapes, and a second set corresponding to the plurality of second colored shapes.

The arithmetic educational game may further include an ionizing rod disposed on at least a portion of the game board to emit an ionized corona on the game board to remove static electricity therefrom.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front view of an arithmetic educational game, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Arithmetic Educational Game 100
Game Board 110
First Colored Shapes 111
Second Colored Shapes 112
Third Colored Shapes 113
Fourth Colored Shapes 114
Aperture 115
Ball 120
Fastener Portion 121
Cards 130
First Set 131
First Label 131a
Second Set 132
Second Label 132a
Ionizing Rod 140
Power Source 150

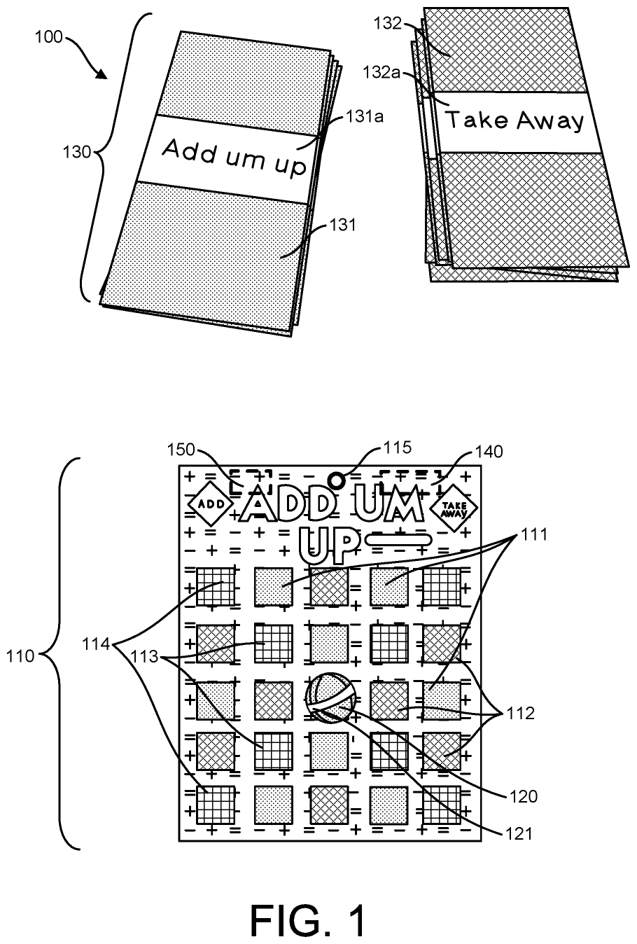

FIG. 1 illustrates a front view of an arithmetic educational game 100, according to an exemplary embodiment of the present general inventive concept.

The arithmetic educational game 100 may be constructed from at least one of metal, plastic, wood, glass, ceramic, and rubber, etc., but is not limited thereto.

The arithmetic educational game 100 may include a game board 110, a ball 120, a plurality of cards 130, an ionizing rod 140, and a power source 150, but is not limited thereto.

Referring to FIG. 1, the game board 110 is illustrated to have a rectangular prism shape. However, the game board 110 may be rectangular, circular, pentagonal, hexagonal, octagonal, or any other shape known to one of ordinary skill in the art, but is not limited thereto.

A plurality of mathematical operators may be disposed on at least a portion of a surface of the game board 110 to identify the mathematical operations being taught. For example, the mathematical operators of the game board 110 may include at least one of addition, subtraction, multiplication, and division.

The game board 110 may include a plurality of first colored shapes 111, a plurality of second colored shapes 112, a plurality of third colored shapes 113, a plurality of fourth colored shapes 114, and an aperture 115, but is not limited thereto.

Referring again to FIG. 1, the plurality of first colored shapes 111, the plurality of second colored shapes 112, the plurality of third colored shapes 113, and/or the plurality of fourth colored shapes 114 are illustrated to have square shapes. However, the plurality of first colored shapes 111, the plurality of second colored shapes 112, the plurality of third colored shapes 113, and/or the plurality of fourth colored shapes 114 may be rectangular, circular, pentagonal, hexagonal, octagonal, or any other shape known to one of ordinary skill in the art, but is not limited thereto.

The plurality of first colored shapes 111 may be disposed on at least a portion of a front surface of the game board 110. The plurality of first colored shapes 111 may have a first color (i.e. yellow).

The plurality of second colored shapes 112 may be disposed on at least a portion of the front surface of the game board 110. The plurality of second colored shapes 112 may have a second color (i.e. red).

The plurality of third colored shapes 113 may be disposed on at least a portion of the front surface of the game board 110. The plurality of third colored shapes 113 may have a third color (i.e. gray).

The plurality of fourth colored shapes 114 may be disposed on at least a portion of the front surface of the game board 110. The plurality of fourth colored shapes 114 may have the third color and/or a fourth color.

Collectively, the plurality of first colored shapes 111, the plurality of second colored shapes 112, the plurality of third colored shapes 113, and/or the plurality of fourth colored shapes 114 may be intermittently and alternately arranged in a pattern, such as a square, on the game board 110. However, the pattern may be rectangular, circular, pentagonal, hexagonal, octagonal, or any other shape known to one of ordinary skill in the art, but is not limited thereto.

In other words, each of the plurality of first colored shapes 111 may be spaced apart on the game board 110, such that each of the plurality of second colored shapes 112 and/or each of the plurality of third colored shapes 113 may be disposed therebetween. Also, each of the plurality of second colored shapes 112 and/or each of the plurality of third colored shapes 113 may be spaced apart with respect to each of the plurality of first colored shapes 111.

Each of the plurality of fourth colored shapes 114 may be disposed at each corner of the pattern.

Furthermore, the plurality of first colored shapes 111, the plurality of second colored shapes 112, the plurality of third colored shapes 113, and/or the plurality of fourth colored shapes 114 may include a fastener disposed on each shape thereof. For example, the fastener may include hooks and loops, a magnet, and/or an adhesive, but is not limited thereto.

The aperture 115 may allow the game board 110 to be suspended from a hook disposed on a wall.

The ball 120 may include a fastener portion 121, but is not limited thereto.

The fastener portion 121 may include hooks and loops, a magnet, and/or an adhesive, but is not limited thereto.

The fastener portion 121 may be disposed on and/or within at least a portion of the ball 120. The fastener portion 121 may facilitate connecting the ball 120 to at least one of the plurality of first colored shapes 111, the plurality of second colored shapes 112, the plurality of third colored shapes 113, and the plurality of fourth colored shapes 114. In other words, each of the plurality of first colored shapes 111, each of the plurality of second colored shapes 112, each of the plurality of third colored shapes 113, and/or each of the plurality of fourth colored shapes 114 may receive the ball 120 thereupon in response to connecting to the fastener portion 121, after the ball 120 has been propelled (i.e. thrown) toward the plurality of first colored shapes 111, the plurality of second colored shapes 112, the plurality of third colored shapes 113, and/or the plurality of fourth colored shapes 114. As such, the fastener of the plurality of first colored shapes 111, the plurality of second colored shapes 112, the plurality of third colored shapes 113, and/or the plurality of fourth colored shapes 114 may prevent the ball 120 from falling therefrom.

The plurality of cards 130 may include a first set 131 and a second set 132, but is not limited thereto.

The first set 131 may include a first label 131a (e.g., “Add um up”), but is not limited thereto.

The first set 131 may have the first color corresponding to the color of the plurality of first colored shapes 111. The first label 131a may be disposed on a rear surface of each of the first set 131. Additionally, the first label 131a may identify a first mathematical operation to perform, such as addition.

Each of the first set 131 may have a number disposed on a front surface thereof. Specifically, the first set 131 may have twenty-five cards, such that each of the first set 131 may have a number ranging from one through twenty-five. In other words, there may be only one number one, one number two, one number three, etc.

Furthermore, a card from the first set 131 may be drawn in response to the ball 120 connecting to at least one of the plurality of first colored shapes 111.

The second set 132 may include a second label 132a (e.g., “Take Away”), but is not limited thereto.

The second set 132 may have the second color corresponding to the color of the plurality of second colored shapes 112. The second label 132a may be disposed on a rear surface of each of the second set 132. Additionally, the second label 132a may identify a second mathematical operation to perform, such as subtraction.

Each of the second set 132 may have a number disposed on a front surface thereof. Specifically, the second set 132 may have twenty-five cards, such that each of the second set 132 may have a number ranging from one through twenty-five. In other words, there may be only one number one, one number two, one number three, etc.

Furthermore, a card from the second set 132 may be drawn in response to the ball 120 connecting to at least one of the plurality of second colored shapes 112.

The ionizing rod 140 may be disposed away from the plurality of first colored shapes 111, the plurality of second colored shapes 112, the plurality of third colored shapes 113, and/or the plurality of fourth colored shapes 114 on at least a portion of the game board 110.

The ionizing rod 140 may emit an ionized corona toward the plurality of first colored shapes 111, the plurality of second colored shapes 112, the plurality of third colored shapes 113, and/or the plurality of fourth colored shapes 114 to remove static electricity therefrom. In other words, the ionizing rod 140 may prevent static electricity from collecting on the game board 110.

The power source 150 may include a battery and a solar cell, but is not limited thereto.

The power source 150 may send power to the ionizing rod 140.

The arithmetic educational game 100 may be played with at least two players. The arithmetic educational game 100 may be played by a player throwing the ball 120 toward the game board 100, such that the ball 120 may connect to at least one of the plurality of first colored shapes 111, the plurality of second colored shapes 112, the plurality of third colored shapes 113, and/or the plurality of fourth colored shapes 114. If no connection is made, the player is considered to have made no score and another player may begin a turn.

If a connection is made on at least one of the plurality of first colored shapes 111, a card from the first set 131 may be drawn to determine a point, which is added to a score. If a connection is made on at least one of the plurality of second colored shapes 112, a card from the second set 132 may be drawn to determine another point, which is subtracted from the score. If a connection is made on at least one of the plurality of third colored shapes 113, the player may elect to add or subtract five points from the score. If a connection is made on at least one of the plurality of fourth colored shapes 114, the player may elect to add or subtract ten points from the score.

The first set 131 and/or the second set 132 may be reshuffled in response to a last card being drawn, such that a new deck may be created.

The first player to score exactly fifty points wins. Any player that reaches less than negative fifty points is automatically eliminated.

Therefore, the arithmetic educational game 100 may allow a player to engage in a physical activity and learn math operations at the same time.

The present general inventive concept may include an arithmetic educational game 100, including a game board 110, including a plurality of first colored shapes 111 disposed on at least a portion of a front surface of the game board 110, a plurality of second colored shapes 112 disposed on at least a portion of the front surface of the game board 110, a plurality of third colored shapes 113 disposed on at least a portion of the front surface of the game board 110, and a plurality of fourth colored shapes 114 disposed on at least a portion of the front surface of the game board 110, a ball 120 to propel toward the game board 110, such that the ball 120 connects to at least one of the plurality of first colored shapes 111, the plurality of second colored shapes 112, the plurality of third colored shapes 113, and the plurality of fourth colored shapes 114, and a plurality of cards 130 to be drawn in response to the ball 120 connecting to at least one of the plurality of first colored shapes 111 and the plurality of second colored shapes 112.

The plurality of first colored shapes 111 may be a first color.

The plurality of second colored shapes 112 may be a second color.

The plurality of third colored shapes 113 may be a third color.

The plurality of fourth colored shapes 114 may be a fourth color.

The plurality of first colored shapes 111, the plurality of second colored shapes 112, the plurality of third colored shapes 113, and the plurality of fourth colored shapes 114 each may include a fastener to prevent the ball 120 from falling in response to connecting to the game board 110.

The ball 120 may include a fastener portion 121 disposed on a surface of the ball 120 to connect the ball 120 to the game board 110.

The plurality of cards 130 may include a first set 131 corresponding to the plurality of first colored shapes 111, and a second set 132 corresponding to the plurality of second colored shapes 112.

The arithmetic educational game 100 may further include an ionizing rod 140 disposed on at least a portion of the game board 110 to emit an ionized corona on the game board 110 to remove static electricity therefrom.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An arithmetic educational game, comprising:
a game board, comprising:
a plurality of first colored shapes disposed on at least a portion of a front surface of the game board, such that the plurality of first colored shapes comprise hooks and loops, a magnet, and an adhesive,
a plurality of second colored shapes disposed on at least a portion of the front surface of the game board, such that the plurality of second colored shapes comprise hooks and loops, a magnet, and an adhesive,
a plurality of third colored shapes disposed on at least a portion of the front surface of the game board, such that the plurality of third colored shapes comprise hooks and loops, a magnet, and an adhesive, and
a plurality of fourth colored shapes disposed on at least a portion of the front surface of the game board, such that the plurality of fourth colored shapes comprise hooks and loops, a magnet, and an adhesive;
a ball to propel toward the game board, such that the ball connects to at least one of the plurality of first colored shapes, the plurality of second colored shapes, the plurality of third colored shapes, and the plurality of fourth colored shapes;
a plurality of cards to be drawn in response to the ball connecting to at least one of the plurality of first colored shapes and the plurality of second colored shapes; and
an ionizing rod disposed on at least a portion of the game board to emit an ionized corona on the game board to remove static electricity therefrom.

2. The arithmetic educational game of claim 1, wherein the plurality of first colored shapes are a first color.

3. The arithmetic educational game of claim 2, wherein the plurality of second colored shapes are a second color.

4. The arithmetic educational game of claim 3, wherein the plurality of third colored shapes are a third color.

5. The arithmetic educational game of claim 4, wherein the plurality of fourth colored shapes are a fourth color.

6. (canceled)

7. The arithmetic educational game of claim 1, wherein the ball comprises:
a fastener portion disposed on a surface of the ball to connect the ball to the game board.

8. The arithmetic educational game of claim 1, wherein the plurality of cards comprise:
a first set corresponding to the plurality of first colored shapes; and
a second set corresponding to the plurality of second colored shapes.

9. (canceled)

10. (canceled)
